(19) United States
(12) Patent Application Publication
(10) Pub. No.: US 2006/0176292 A1
(43) Pub. Date: Aug. 10, 2006

(54) Voltage feedback controlled circuit and method for organic electroluminescent panel

(75) Inventor: Chi-Chih Liao, Taipei City (TW)

Correspondence Address: BIRCH STEWART KOLASCH & BIRCH, PO BOX 747, FALLS CHURCH, VA, 22040-0747, US

(73) Assignee: RITDISPLAY CORPORATION

(21) Appl. No.: 11/053,932

(22) Filed: Feb. 10, 2005

(51) Int. Cl. G09G 5/00

(52) U.S. Cl. 345/211

(57) ABSTRACT

A voltage feedback controlled circuit for an organic electroluminescent panel comprises at least one power supply and a voltage feedback detecting controlling circuit. In this case, the voltage feedback detecting controlling circuit connects with the organic electroluminescent panel and the power supply. The voltage feedback detecting controlling circuit detects at least one working voltage of the organic electroluminescent panel, and outputs a controlling signal depending on the relation between the working voltage and luminance of the organic electroluminescent panel. The power supply outputs at least one driving current or driving voltage depending on the controlling signal to drive the organic electroluminescent panel.

### BACKGROUND OF THE INVENTION

1. Field of Invention

The invention relates to a controlled circuit and a controlled method of an organic electroluminescent panel and, in particular, to a voltage feedback controlled circuit and a voltage feedback controlled method for an organic electroluminescent panel.

2. Related Art

The flat-panel displays have been developed based on the trend towards high brightness, planar and thinner structures and power saving. Accordingly, the organic electroluminescent panel is one of the most potential products in optoelectronics industries. The organic electroluminescent panel uses the self-emitting feature of organic functional materials to perform display purposes. According to the molecular weight of the organic functional materials used in organic electroluminescent panel, it could be classified into the small molecule OLED (SM-OLED) and polymer light-emitting display (PLED).

However, the organic functional materials have intrinsic limitations in stability, so the luminance of the organic electroluminescent panel may gradually decrease when the time passes away in use. As shown in FIG. 1, when the driving circuit of the organic electroluminescent panel is constant, the luminance of the organic electroluminescent panel is decreasing as the time is increasing. In addition, the organic functional materials of different colors have different stabilities. Regarding to the full color organic electroluminescent panel, it is a difficult subject to develop the materials of three primary colors (Red, Green and Blue) with the same stabilities and light-emitting efficiencies. Therefore, after a long-term usage, the full color organic electroluminescent panel may have the problems of non-uniform luminance and color shifting.

To solve the above-mentioned problems, the conventional solution is to add a photodetector on the organic electroluminescent panel. The photodetector can detect the luminance of the organic electroluminescent panel. Then, the outputted driving current for controlling the luminance of the organic electroluminescent panel can be adjusted according to the detected original luminance.

This conventional solution must install an extra photodetector on the organic electroluminescent panel. However, the extra photodetector inevitably increases the whole size of the organic electroluminescent device, which does not match the trend towards lightweight and compact. In addition, the extra photodetector can only detect the luminance of the periphery areas of the organic electroluminescent panel, but can not detect the luminance of the central areas of the organic electroluminescent panel. Thus, when the luminance of the periphery areas and the central areas of the organic electroluminescent panel is non-uniform, or when the luminance of the central areas of the organic electroluminescent panel is non-uniform, the above-mentioned conventional solution may fail to adjust the luminance of the organic electroluminescent panel.

It is therefore an important subject of the invention to provide a voltage feedback controlled circuit and a voltage feedback controlled method for an organic electroluminescent panel for solving the problems.

### SUMMARY OF THE INVENTION

In view of the foregoing, the invention is to provide a voltage feedback controlled circuit for an organic electroluminescent panel, which has a voltage feedback controlled function, and a voltage feedback controlled method applied in the voltage feedback controlled circuit.

To achieve the above, a voltage feedback controlled circuit for an organic electroluminescent panel comprises at least one power supply and a voltage feedback detecting controlling circuit. In the invention, the voltage feedback detecting controlling circuit connects with the organic electroluminescent panel and the power supply. The voltage feedback detecting controlling circuit detects at least one working voltage of the organic electroluminescent panel, and outputs a controlling signal depending on a relation between the working voltage and luminance of the organic electroluminescent panel. Then, the power supply outputs at least one driving current or at least one driving voltage according to the controlling signal for driving the organic electroluminescent panel.

The voltage feedback detecting controlling circuit comprises a voltage feedback detecting circuit and a controlling circuit. The voltage feedback detecting circuit connects with the organic electroluminescent panel and detects at least one working voltage of the organic electroluminescent panel. The controlling circuit connects with the voltage feedback detecting circuit and outputs a controlling signal depending on a relation between the working voltage and luminance of the organic electroluminescent panel. The power supply outputs at least one driving current or at least one driving voltage according to the controlling signal for driving the organic electroluminescent panel.

Wherein, the relation between the working voltage and the luminance of the organic electroluminescent panel can be a predetermined relation, which is obtained according to experimental data in cooperating with a statistical regression method, such as a linear regression method or a multinomial regression method.

The invention also discloses a voltage feedback controlled method for an organic electroluminescent panel, which comprises the steps of: detecting at least one working voltage of the organic electroluminescent panel, generating a controlling signal depending on the working voltage, and controlling at least one power supply to output at least one driving current or at least one driving voltage according to the controlling signal for driving the organic electroluminescent panel.

The invention also discloses an organic electroluminescent device with a voltage feedback controlled function, which comprises an organic electroluminescent panel, at least one power supply and a voltage feedback detecting controlling circuit. In the invention, the voltage feedback detecting controlling circuit connects with the organic electroluminescent panel and the power supply. The voltage feedback detecting controlling circuit detects at least one working voltage of the organic electroluminescent panel and outputs a controlling signal depending on the working voltage. Then, the power supply outputs at least one driving current or at least one driving voltage according to the controlling signal for driving the organic electroluminescent panel.

The voltage feedback detecting controlling circuit comprises a voltage feedback detecting circuit and a controlling circuit. In the invention, the voltage feedback detecting circuit connects with the organic electroluminescent panel and detects at least one working voltage of the organic electroluminescent panel. The controlling circuit connects with the voltage feedback detecting circuit and outputs a controlling signal depending on the working voltage. Then, the power supply outputs at least one driving current or at least one driving voltage according to the controlling signal for driving the organic electroluminescent panel.

As mentioned above, the voltage feedback controlled circuit and method for an organic electroluminescent panel can detect at least one working voltage of the organic electroluminescent panel, and output a controlling signal according to the working voltage. The power supply can then output at least one driving current or at least one driving voltage according to the controlling signal for driving the organic electroluminescent panel. Comparing with the prior art, the invention need only the internal voltage feedback detecting circuit for retrieving the current working voltage of the luminance of the organic electroluminescent panel, and the retrieved working voltage can be then used to adjust the current or voltage outputted from the power supply so as to control the luminance of the organic electroluminescent panel. Thus, the invention does not require the conventional extra photodetector, so that the size of the whole organic electroluminescent device is smaller for matching the trend of lightweight and compact. In addition, the invention also overcomes the limitation of different stabilities and light-emitting efficiencies for the materials of three primary colors (Red, Green and Blue). Thus, the present materials of three primary colors with different stabilities and light-emitting efficiencies can be freely applied in the full color organic electroluminescent panel. Moreover, the invention can detect the working voltages in different areas of the organic electroluminescent panel, and can adjust any specific area of the organic electroluminescent panel. Therefore, the luminance uniformity and color stability of the whole organic electroluminescent panel can be maintained.

### BRIEF DESCRIPTION OF THE DRAWINGS

The invention will become more fully understood from the detailed description given herein below illustration only, and thus is not limitative of the present invention, and wherein:

FIG. 1 is a coordinate diagram showing the relationship between the time and the luminance when the driving circuit of the organic electroluminescent panel is constant;

FIG. 2 is a coordinate diagram showing the relationship between the time and the working voltage when the driving circuit of the organic electroluminescent panel is constant;

FIG. 3 is a coordinate diagram showing the relationship between the working voltage and the luminance when the driving circuit of the organic electroluminescent panel is constant;

FIG. 4 is a block diagram showing a voltage feedback controlled circuit according to a first embodiment of the invention;

FIG. 5 is a schematic view showing areas A to C of the voltage feedback controlled circuit according to the first embodiment of the invention;

FIG. 6 is a block diagram showing a voltage feedback controlled circuit according to a second embodiment of the invention;

FIG. 7 is a flow chart showing a voltage feedback controlled method for an organic electroluminescent panel according to the second embodiment of the invention;

FIG. 8 is a block diagram showing an organic electroluminescent device with a voltage feedback controlled function according to a third embodiment of the invention; and

FIG. 9 is a block diagram showing an organic electroluminescent device with a voltage feedback controlled function according to a fourth embodiment of the invention.

### DETAILED DESCRIPTION OF THE INVENTION

The present invention will be apparent from the following detailed description, which proceeds with reference to the accompanying drawings, wherein the same references relate to the same elements.

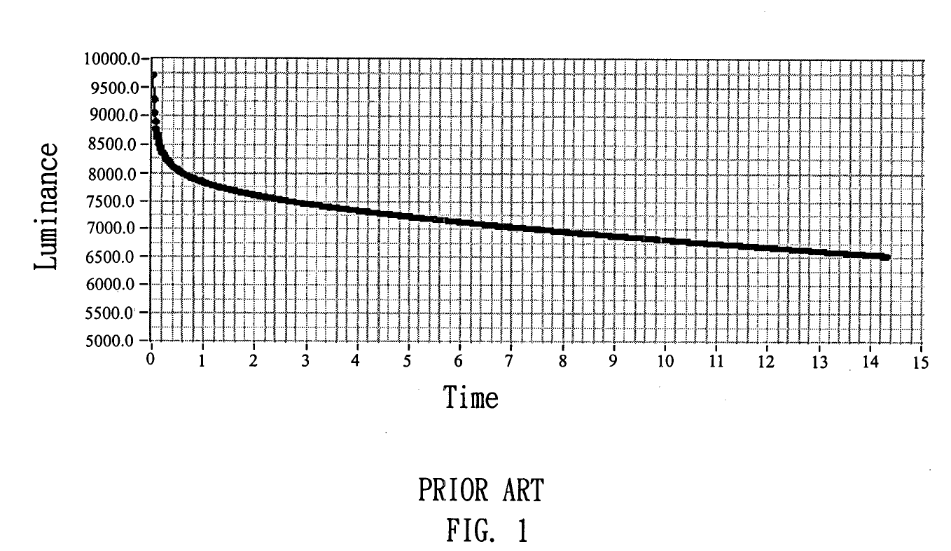

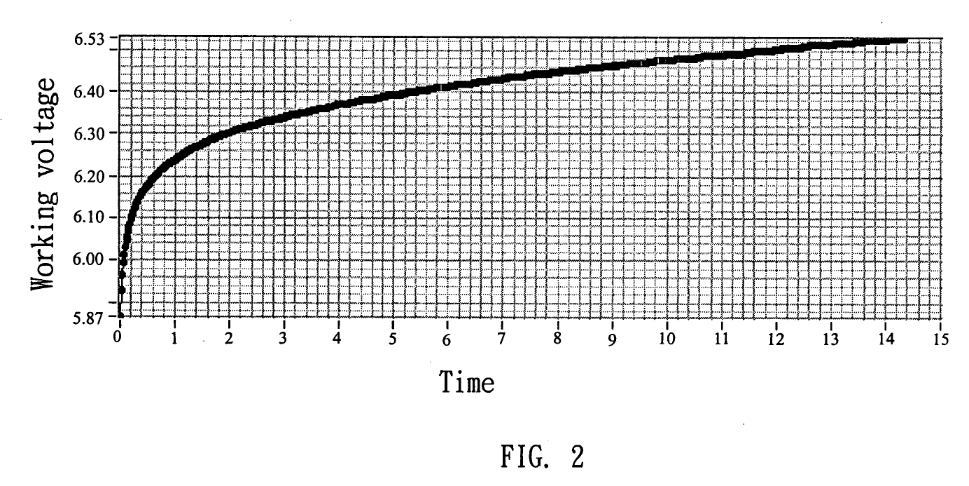

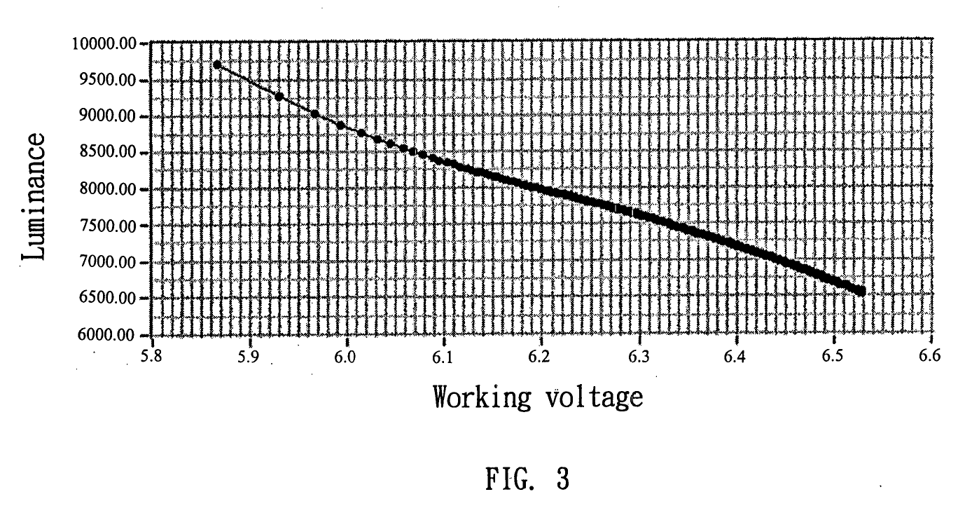

As shown in the previously mentioned FIG. 1, when the driving circuit of the organic electroluminescent panel is constant, the luminance of the organic electroluminescent panel is decreasing as the time is increasing. As shown in FIG. 2, the working voltage is increasing as the time is increasing. According to FIGS. 1 and 2, when the driving circuit of the organic electroluminescent panel is constant, the working voltage and the luminance of the organic electroluminescent panel have a (inverse-ratio) linear relation as shown in FIG. 3.

In the embodiment, the relation between the working voltage and the luminance of the organic electroluminescent panel can be a predetermined relation, which is obtained as shown in FIG. 3 according to experimental data of different experiments with a statistical regression method, such as a linear regression method or a multinomial regression method.

According to the relation, when the present working voltage of an organic electroluminescent panel is detected, the current luminance of the organic electroluminescent panel can be calculated. The power supply can be then controlled according to the working voltage to output a driving current or driving voltage for adjusting the luminance of the organic electroluminescent panel.

### First Embodiment

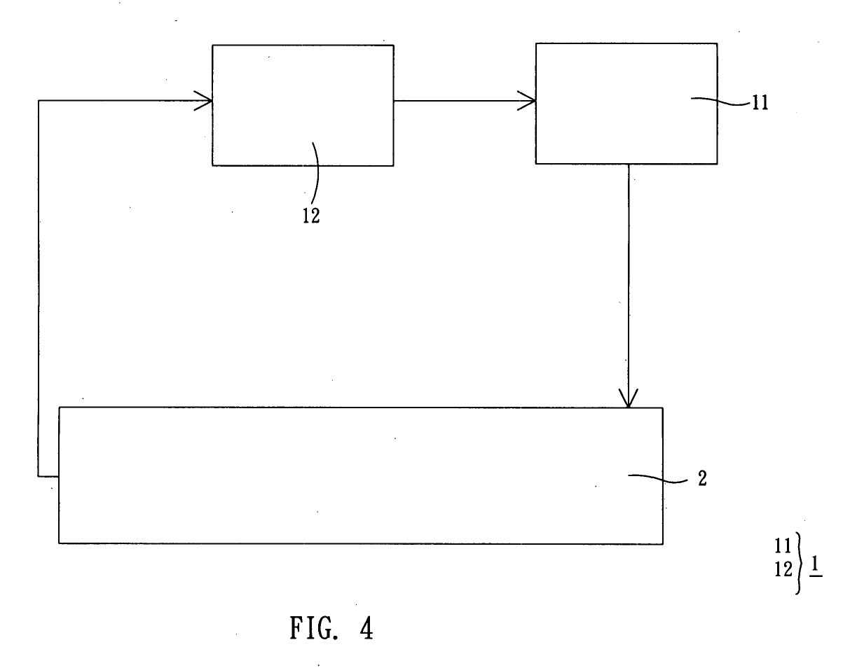

With reference to FIG. 4, a voltage feedback controlled circuit 1 according to the first embodiment of the invention comprises at least one power supply 11 and a voltage feedback detecting controlling circuit 12. In the embodiment, the voltage feedback detecting controlling circuit 12 connects with an organic electroluminescent panel 2 and the power supply 11. The voltage feedback detecting controlling circuit 12 detects at least one working voltage of the organic electroluminescent panel 2, and outputs a controlling signal depending on a relation between the working voltage and luminance of the organic electroluminescent panel 2. Then, the power supply 11 outputs at least one driving current or at least one driving voltage according to the controlling signal for driving the organic electroluminescent panel 2.

In the embodiment, the organic electroluminescent panel 2 comprises at least one pixel. The pixel comprises a substrate, a first electrode, an organic functional layer and a second electrode. The first electrode, the organic functional layer and the second electrode are disposed over the substrate in sequence.

In the present embodiment, the substrate can be a flexible or a rigid substrate. The substrate can also be a plastic or glass substrate. In particular, the flexible substrate or plastic substrate comprises polycarbonate (PC), polyester (PET), cyclic olefin copolymer (COC) and metallocene-based cyclic olefin copolymer (mCOC). In addition, the substrate can be a silicon substrate.

The first electrode is formed on the substrate by sputtering or ion plating. Herein, the first electrode is usually used as an anode and made of a transparent conductive metal oxide, such as indium-tin oxide (ITO), aluminum-zinc oxide (AZO) or indium-zinc oxide (IZO).

The organic functional layer usually comprises a hole-injecting layer, a hole-transporting layer, a light-emitting layer, an electron-transporting layer, an electron-injecting layer and their combination (not shown). Herein, the organic functional layer may be formed over the first electrode by utilizing evaporation, spin coating, ink-jet printing, transfer or printing. In addition, the light emitted from the organic functional layer is blue, green, red, white, other monochromic lights or colorful light, which is a combination of monochromatic lights.

In addition, the second electrode is disposed over the organic functional layer. Herein, the second electrode can be formed by evaporation or sputtering. The material of the second electrode can be but not limited to aluminum, calcium, magnesium, indium, zinc, manganese, copper, silver, gold and magnesium alloy. The magnesium alloy can be, for example but not limited to, Mg:Ag alloy, Mg:In alloy, Mg:Sn alloy, Mg:Sb alloy or Mg:Te alloy.

With reference to FIG. 4, the voltage feedback detecting controlling circuit 12 comprises a voltage feedback detecting circuit and a controlling circuit.

In this case, the voltage feedback detecting circuit connects with the organic electroluminescent panel 2 for detecting the working voltage of the organic electroluminescent panel 2. In the present embodiment, the voltage feedback detecting circuit can detect the working voltages of different areas in the organic electroluminescent panel 2. Of course, the voltage feedback detecting circuit can detect the working voltage of a specific location in the organic electroluminescent panel 2.

The controlling circuit connects with the voltage feedback detecting circuit and outputs a controlling signal depending on a relation between the working voltage and luminance of the organic electroluminescent panel 2 (as shown in FIG. 3). Then, the power supply 11 outputs at least one driving current or driving voltage according to the controlling signal to drive the organic electroluminescent panel 2. In the current embodiment, the power supply 11 can be a single power supply or several individual power supplies.

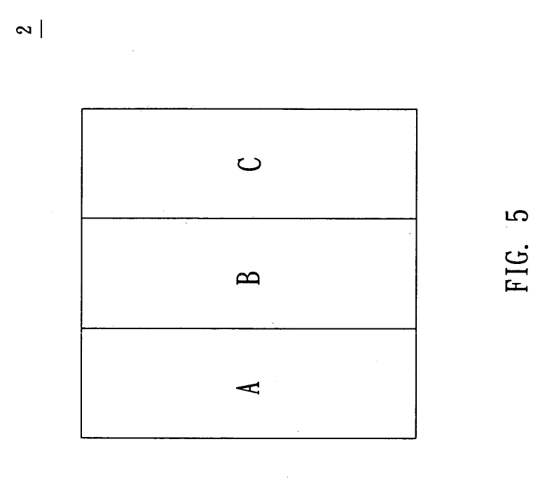

In this embodiment, the voltage feedback detecting circuit detects the working voltages of areas A to C of the organic electroluminescent panel 2 (as shown in FIG. 5). The detected working voltages are then transferred to the controlling circuit, and the controlling circuit outputs controlling signals according to the working voltages. The power supply 11 then outputs corresponding driving currents or driving voltages according to the controlling signals for controlling the luminance of the areas A to C of the organic electroluminescent panel 2. Therefore, the luminance uniformity and color stability of the organic electroluminescent panel 2 can be maintained.

Certainly, the voltage feedback detecting circuit can detect the working voltages of the specific locations of the full color organic electroluminescent panel 2, which emits red light, green light or blue light. According to the detected working voltages, the controlling circuit controls the power supply 11 to output corresponding driving currents or driving voltages for controlling the luminance of the locations of the organic electroluminescent panel 2, which emits red light, green light or blue light. Therefore, the problem of light shifting caused by the different stabilities of the red organic functional material, the green organic functional material and the blue functional material.

In addition, the organic electroluminescent panel 2, the voltage feedback detecting controlling circuit 12 (including the voltage feedback detecting circuit and controlling circuit), and the power supply 11 are connected with each other.

### Second Embodiment

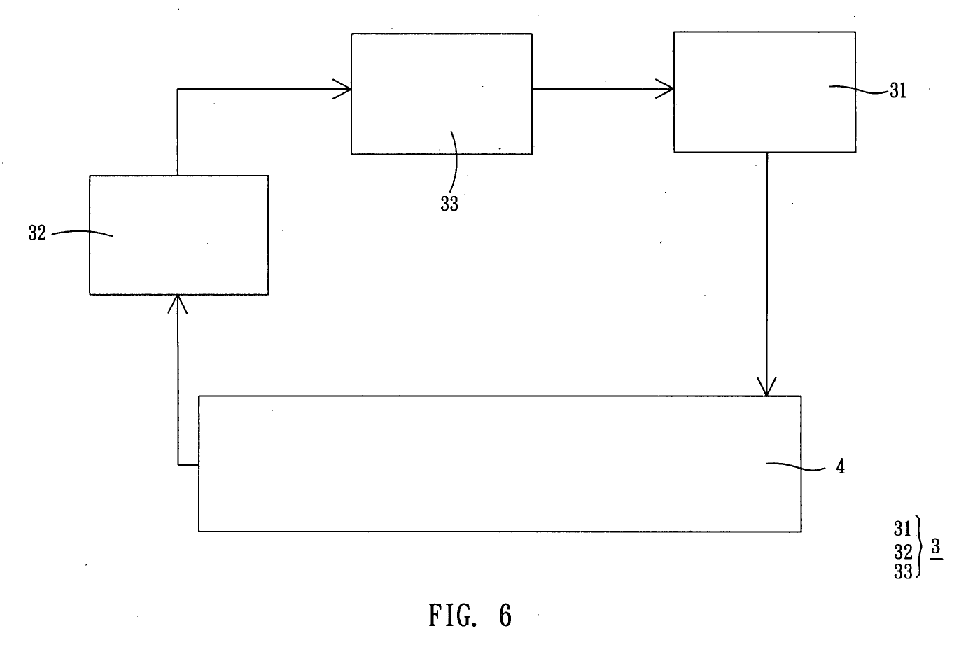

With reference to FIG. 6, a voltage feedback controlled circuit 3 according to the second embodiment of the invention comprises at least one power supply 31, a voltage feedback detecting circuit 32 and a controlling circuit 33. In the embodiment, the voltage feedback detecting circuit 32 connects with an organic electroluminescent panel 4 and detects at least one working voltage of the organic electroluminescent panel 4. The controlling circuit 33 connects with the voltage feedback detecting circuit 32 and outputs a controlling signal depending on a relation between the working voltage and luminance of the organic electroluminescent panel 4. The power supply 31 outputs at least one driving current or at least one driving voltage according to the controlling signal for driving the organic electroluminescent panel 4.

The functions and features of the power supply 31, voltage feedback detecting circuit 32, controlling circuit 33 and organic electroluminescent panel 4 are the same as those described in the first embodiment, so the detailed descriptions are omitted for concise purpose.

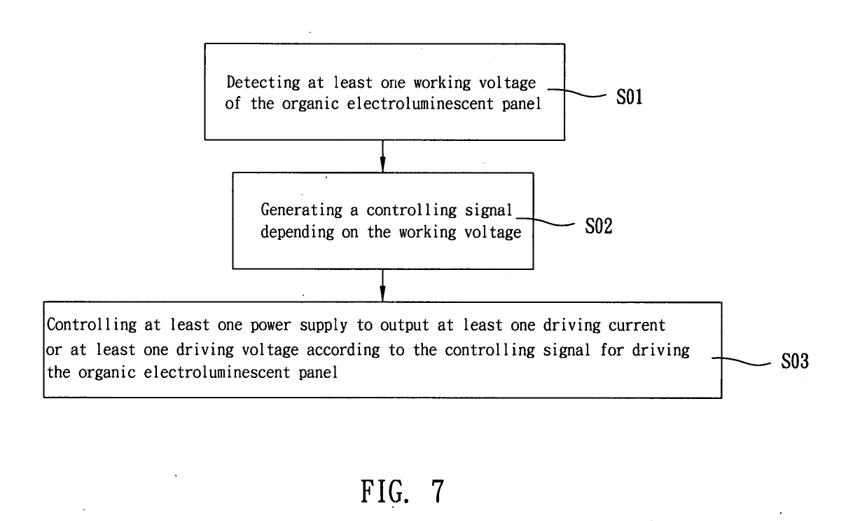

Hereinafter, the voltage feedback controlled method of an organic electroluminescent panel according to the second embodiment of the invention will be described with reference to FIG. 7.

As shown in FIG. 7, the voltage feedback controlled method of an organic electroluminescent panel according to the second embodiment of the invention comprises the following steps: detecting at least one working voltage of the organic electroluminescent panel (step S01), generating a controlling signal depending on the working voltage (step S02), and controlling at least one power supply to output at least one driving current or at least one driving voltage according to the controlling signal for driving the organic electroluminescent panel (step S03).

In this embodiment, the functions and features of the organic electroluminescent panel are the same as those of the previously mentioned organic electroluminescent panel 4, so the detailed descriptions are omitted for concise purpose.

In step S01, a voltage feedback detecting circuit is used to detect at least one working voltage of the organic electroluminescent panel. Herein, the functions and features of the voltage feedback detecting circuit are the same as those of the previously mentioned voltage feedback detecting circuit 32, so the detailed descriptions are omitted for concise purpose.

In step S02, a controlling circuit generates a controlling signal depending on the working voltage. Herein, the functions and features of the controlling circuit are the same as those of the previously mentioned controlling circuit 33, so the detailed descriptions are omitted for concise purpose.

In step S03, at least one power supply is controlled to output at least one driving current or at least one driving voltage according to the controlling signal for driving the organic electroluminescent panel. Herein, the functions and features of the power supply are the same as those of the previously mentioned power supply 1 or 31, so the detailed descriptions are omitted for concise purpose.

To be noted, the voltage feedback detecting circuit and the controlling circuit employed in the step S02 and the step S03 can be merged into a voltage feedback detecting controlling circuit as described in the first embodiment.

### Third Embodiment

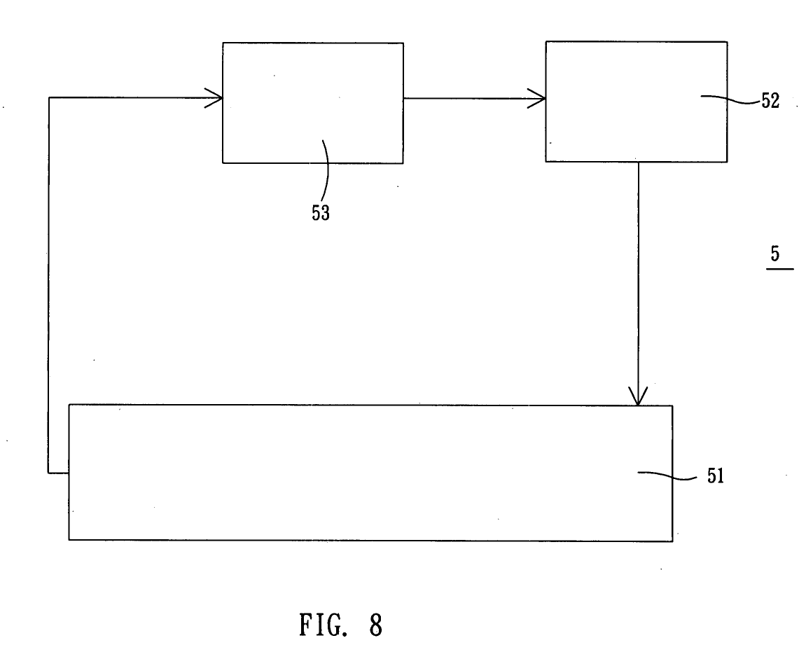

With reference to FIG. 8, an organic electroluminescent device 5 with a voltage feedback controlled function according to the third embodiment of the invention comprises an organic electroluminescent panel 51, at least one power supply 52 and a voltage feedback detecting controlling circuit 53. In the embodiment, the voltage feedback detecting controlling circuit 53 connects with the organic electroluminescent panel 51 and the power supply 52. The voltage feedback detecting controlling circuit 53 detects at least one working voltage of the organic electroluminescent panel 51 and outputs a controlling signal depending on the working voltage. Then, the power supply 52 outputs at least one driving current or at least one driving voltage according to the controlling signal for driving the organic electroluminescent panel 51.

Herein, the voltage feedback detecting controlling circuit 53 comprises a voltage feedback detecting circuit and a controlling circuit. The functions and features of the voltage feedback detecting controlling circuit 53 (comprising the voltage feedback detecting circuit and the controlling circuit) are the same as those described in the first embodiment, so the detailed descriptions are omitted for concise purpose. In addition, the functions and features of the organic electroluminescent panel 51 and the power supply 52 are the same as those described in the first embodiment, so the detailed descriptions are omitted for concise purpose.

### Fourth Embodiment

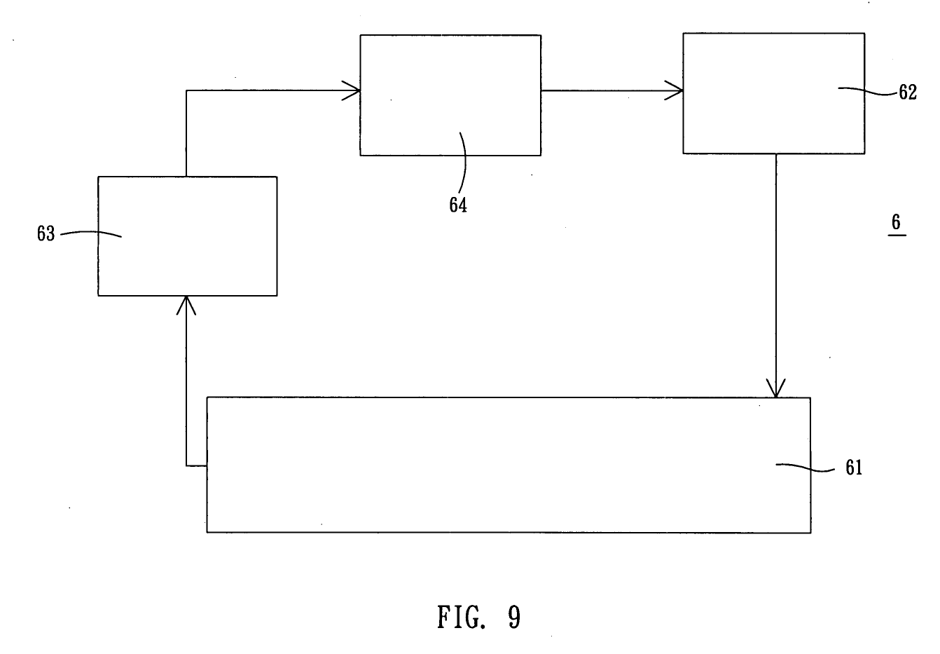

With reference to FIG. 9, an organic electroluminescent device 6 with a voltage feedback controlled function according to the fourth embodiment of the invention comprises an organic electroluminescent panel 61, at least one power supply 62, a voltage feedback detecting circuit 63 and a controlling circuit 64. In this embodiment, the voltage feedback detecting circuit 63 connects with the organic electroluminescent panel 61 and detects at least one working voltage of the organic electroluminescent panel 61. The controlling circuit 64 connects with the voltage feedback detecting circuit 63 and outputs a controlling signal depending on the working voltage detected by the voltage feedback detecting circuit 63. Then, the power supply 62 outputs at least one driving current or at least one driving voltage according to the controlling signal for driving the organic electroluminescent panel 61.

In this embodiment, the functions and features of the organic electroluminescent panel 61, the power supply 62, the voltage feedback detecting circuit 63 and the controlling circuit 64 are the same as those described in the second embodiment, so the detailed descriptions are omitted for concise purpose.

In summary, the voltage feedback controlled circuit and method for an organic electroluminescent panel can detect at least one working voltage of the organic electroluminescent panel, and output a controlling signal according to the working voltage. The power supply can then output at least one driving current or at least one driving voltage according to the controlling signal for driving the organic electroluminescent panel. Comparing with the prior art, the invention need only the internal voltage feedback detecting circuit for retrieving the current working voltage of the luminance of the organic electroluminescent panel, and the retrieved working voltage can be then used to adjust the current or voltage outputted from the power supply so as to control the luminance of the organic electroluminescent panel. Thus, the invention does not require the conventional extra photodetector, so that the size of the whole organic electroluminescent device is smaller for matching the trend of lightweight and compact. In addition, the invention also overcomes the limitation of different stabilities and light-emitting efficiencies for the materials of three primary colors (Red, Green and Blue). Thus, the present materials of three primary colors with different stabilities and light-emitting efficiencies can be freely applied in the full color organic electroluminescent panel. Moreover, the invention can detect the working voltages in different areas of the organic electroluminescent panel, and can adjust any specific area of the organic electroluminescent panel. Therefore, the luminance uniformity and color stability of the whole organic electroluminescent panel can be maintained.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A voltage feedback controlled circuit for an organic electroluminescent panel, comprising:
at least one power supply; and
a voltage feedback detecting controlling circuit, which connects with the organic electroluminescent panel and the power supply, detects at least one working voltage of the organic electroluminescent panel, and outputs a controlling signal depending on a relation between the working voltage and luminance of the organic electroluminescent panel, wherein the power supply outputs at least one driving current or at least one driving voltage according to the controlling signal for driving the organic electroluminescent panel.

2. The voltage feedback controlled circuit of claim 1, wherein the organic electroluminescent panel comprises at least one pixel.

3. The voltage feedback controlled circuit of claim 2, wherein the pixel comprises a substrate, a first electrode, at least one organic functional layer and a second electrode, and the first electrode, the organic functional layer and the second electrode are disposed over the substrate in sequence.

4. The voltage feedback controlled circuit of claim 1, wherein the organic electroluminescent panel, the voltage feedback detecting controlling circuit and the power supply are connected with each other.

5. The voltage feedback controlled circuit of claim 1, wherein the relation between the working voltage and the luminance of the organic electroluminescent panel is a predetermined relation.

6. The voltage feedback controlled circuit of claim 5, wherein the predetermined relation is an inverse-ratio linear relation.

7. The voltage feedback controlled circuit of claim 1, wherein the voltage feedback detecting controlling circuit comprising:
a voltage feedback detecting circuit, which connects with the organic electroluminescent panel and detects at least one working voltage of the organic electroluminescent panel; and
a controlling circuit, which connects with the voltage feedback detecting circuit and outputs a controlling signal depending on a relation between the working voltage and luminance of the organic electroluminescent panel, wherein the power supply outputs at least one driving current or at least one driving voltage according to the controlling signal for driving the organic electroluminescent panel.

8. The voltage feedback controlled circuit of claim 7, wherein the organic electroluminescent panel, the voltage feedback detecting circuit, the controlling circuit and the power supply are connected with each other.

9. A voltage feedback controlled method for an organic electroluminescent panel, comprising:
detecting at least one working voltage of the organic electroluminescent panel;
generating a controlling signal depending on the working voltage; and
controlling at least one power supply to output at least one driving current or at least one driving voltage according to the controlling signal for driving the organic electroluminescent panel.

10. The voltage feedback controlled method of claim 9, wherein the organic electroluminescent panel comprises a substrate, a first electrode, at least one organic functional layer and a second electrode, and the first electrode, the organic functional layer and the second electrode are disposed over the substrate in sequence.

11. The voltage feedback controlled method of claim 9, wherein a relation between the working voltage and luminance of the organic electroluminescent panel is a predetermined relation.

12. The voltage feedback controlled method of claim 11, wherein the predetermined relation is an inverse-ratio linear relation.

13. An organic electroluminescent device with a voltage feedback controlled function, comprising:
an organic electroluminescent panel;
at least one power supply; and
a voltage feedback detecting controlling circuit, which connects with the organic electroluminescent panel and the power supply, detects at least one working voltage of the organic electroluminescent panel, and outputs a controlling signal depending on the working voltage, wherein the power supply outputs at least one driving current or at least one driving voltage according to the controlling signal for driving the organic electroluminescent panel.

14. The organic electroluminescent device of claim 13, wherein the organic electroluminescent panel comprises at least one pixel.

15. The organic electroluminescent device of claim 14, wherein the pixel comprises a substrate, a first electrode, at least one organic functional layer and a second electrode, and the first electrode, the organic functional layer and the second electrode are disposed over the substrate in sequence.

16. The organic electroluminescent device of claim 13, wherein a relation between the working voltage and luminance of the organic electroluminescent panel is a predetermined relation.

17. The organic electroluminescent device of claim 16, wherein the predetermined relation is an inverse-ratio linear relation.

18. The organic electroluminescent device of claim 13, wherein the organic electroluminescent panel, the voltage feedback detecting controlling circuit and the power supply are connected with each other.

19. The organic electroluminescent device of claim 13, wherein the voltage feedback detecting controlling circuit comprising:
a voltage feedback detecting circuit, which connects with the organic electroluminescent panel and detects at least one working voltage of the organic electroluminescent panel; and
a controlling circuit, which connects with the voltage feedback detecting circuit and outputs a controlling signal depending on the working voltage, wherein the power supply outputs at least one driving current or at least one driving voltage according to the controlling signal for driving the organic electroluminescent panel.

20. The organic electroluminescent device of claim 19, wherein the organic electroluminescent panel, the voltage feedback detecting circuit, the controlling circuit and the power supply are connected with each other.
